(19) United States
(12) Patent Application Publication
(10) Pub. No.: US 2012/0047863 A1
(43) Pub. Date: Mar. 1, 2012

(54) SYSTEM FOR CLEANING UP YARD DEBRIS

(76) Inventor: Roderick McLellan, Rockland, MA (US)

(21) Appl. No.: 13/165,029

(22) Filed: Jun. 21, 2011

Related U.S. Application Data
(60) Provisional application No. 61/402,259, filed on Aug. 26, 2010.

(51) Int. Cl. A01D 34/49; B65B 67/12

(52) U.S. Cl. 56/16.9; 248/99; 248/101; 56/17.5

(57) ABSTRACT

One example embodiment includes an expandable hoop for securing a bag to a system for cleaning up yard debris. The expandable hoop includes an outer hoop and an inner hoop. The inner hoop is configured to mate with the outer hoop. The inner hoop includes a band, where the band is curved to form a round shape. The inner hoop also includes an overlapping section of the band. The overlapping section can allow an expanded configuration, where the expanded configuration occurs if the inner hoop overlap is small and a contracted configuration, where the contracted configuration occurs if the inner hoop overlap is large.

### CROSS-REFERENCE TO RELATED APPLICATIONS

This application claims the benefit of and priority to U.S. Provisional Patent Application Ser. No. 61/402,259 filed on Aug. 26, 2010, which application is incorporated herein by reference in its entirety.

### BACKGROUND OF THE INVENTION

Recently, there has been increased interest in compostable materials. These materials break down naturally over time. This allows the amount of material in landfills to be reduced significantly, as any materials will eventually decompose, becoming fertilizer for the area in which they are disposed of. As part of this trend, there has been increased interest in the use of compostable bags.

Compostable bags are made of organic material. They can be used to dispose of other organic materials. The benefit conferred by compostable bags is the benefit of storing or packing materials to be disposed of without placing those materials in bags that will themselves produce landfill waste. I.e., a compostable bag allows the materials to be packed and moved to the location at which they will be disposed of. However, the bag itself is compostable meaning that, over time, there will be no residual material left as part of the disposal process. Compostable bags are especially useful for the elimination of yard waste or other plant matter debris.

However, there are some drawbacks in using compostable bags for yard waste. In particular, many times they are used as a dumping place for the material. I.e., the yard waste is obtained thorough a device such as a mower, yard vacuum or similar device. The device stores the resultant debris, which may be mulched by the device, in a cloth bag. The cloth bag is then dumped into a compostable bag for disposal. This leads to a number of drawbacks.

Most significantly, the material is packed much looser after movement. I.e., the device packs the material rather efficiently in the cloth bag. This results from the pressures involved in moving the materials into the cloth bag. However, the cloth bag is then dumped into a compostable bag, which reduces the packing efficiency. In particular, the debris is essentially unpacked by moving it from the cloth bag to the compostable bag, increasing the volume of the debris.

Additionally, moving the cloth bag can be difficult. In particular, the weight can be difficult to lift or maneuver for some users. For example, the user may need to lift the cloth bag higher than the height of the compostable bag. Simultaneously, the user must turn over the cloth bag, dumping the contents from the cloth bag into the compostable bag. This can require a combination of strength and coordination that some users may lack.

In contrast, the user can lift materials, such as leaves or uprooted plants and place them directly into the compostable bag. However, this material is not mulched. This means that the user will be able to place far less material within the compostable bag as there will be empty spaces within the bag. In addition, the material may take far longer to break down, as the decomposable surface area is reduced compared to mulched material.

Accordingly, there is a need in the art for a system that can place yard debris directly in a compostable bag. Additionally, there is a need in the art for the system to mulch the yard debris. Further, there is a need in the art for the system to allow the user to easily change a full compostable bag for an empty compostable bag. In addition, there is a need in the art for the system to pack the yard debris in an efficient configuration within the compostable bag.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes an expandable hoop for securing a bag to a system for cleaning up yard debris. The expandable hoop includes an outer hoop and an inner hoop. The inner hoop is configured to mate with the outer hoop. The inner hoop includes a band, where the band is curved to form a round shape. The inner hoop also includes an overlapping section of the band. The overlapping section can allow an expanded configuration, where the expanded configuration occurs if the inner hoop overlap is small and a contracted configuration, where the contracted configuration occurs if the inner hoop overlap is large.

Another example embodiment includes a system for cleaning up yard debris. The system includes a lawn mower. The lawn mower is configured to mulch the yard debris and includes a blade, where the blade is configured to spin approximately parallel to the ground. The system also includes a pump, where the pump is configured to lift the mulch created by the mower, and a bag. The bag is configured to receive the mulch lifted by the pump. The system further includes a filter, where the filter is located at the attachment of the pump and the bag. The system additionally includes an expandable hoop, where the expandable hoop is configured to attach the bag to the filter.

Another example embodiment includes a system for cleaning up yard debris. The system includes a lawn mower. The lawn mower is configured to mulch the yard debris and includes a blade, where the blade is configured to spin approximately parallel to the ground. The system also includes a pump, where the pump is configured to lift the mulch created by the mower, and a compostable bag. The compostable bag is configured to receive the mulch lifted by the pump and is attached vertically to the mower. Vertical attachment of the compostable bag allows more mulched yard debris to be packed in the compostable bag and prevents the mulched yard debris from moving toward the operator. The system further includes a filter, where the filter is located at the attachment of the pump and the compostable bag. The system additionally includes an expandable hoop, where the expandable hoop is configured to attach the compostable bag to the filter. The expandable hoop includes an outer hoop and an inner hoop. The inner hoop is configured to mate with the outer hoop and includes an overlapping section. The overlapping section is configured to allow an expanded configuration, where the expanded configuration occurs if the inner hoop overlap is small, and a contracted configuration, where the contracted configuration occurs if the inner hoop overlap is large. The inner hoop also includes a first handle, where the first handle is configured to secure the overlapping section, and a second handle, where the second handle is configured to increase or decrease the amount of inner hoop overlap. The expandable hoop also includes an interlock switch, where the interlock switch is configured to disable the system when the outer hoop is not attached to the inner hoop.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a side view of a system for collecting yard debris;

FIG. 1B illustrates a top view of the system for collecting yard debris;

FIG. 1C illustrates a bottom view of the system for collecting yard debris;

FIG. 2A illustrates an example of an adjustable hoop in an expanded position attached to a filter element;

FIG. 2B illustrates an example of the adjustable hoop in a contracted position attached to the filter element;

FIG. 3A illustrates an exploded view of the inner hoop in an expanded position;

FIG. 3B illustrates an exploded view of the inner hoop in a contracted position;

FIG. 4A illustrates an example of an interlock switch in a disabled position; and

FIG. 4B illustrates an example of an interlock switch in an enabled position.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

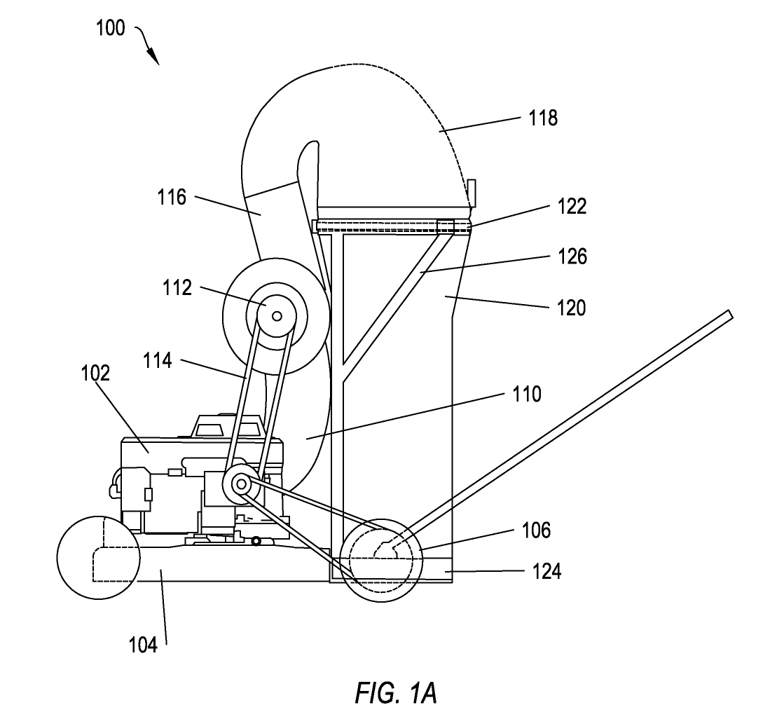

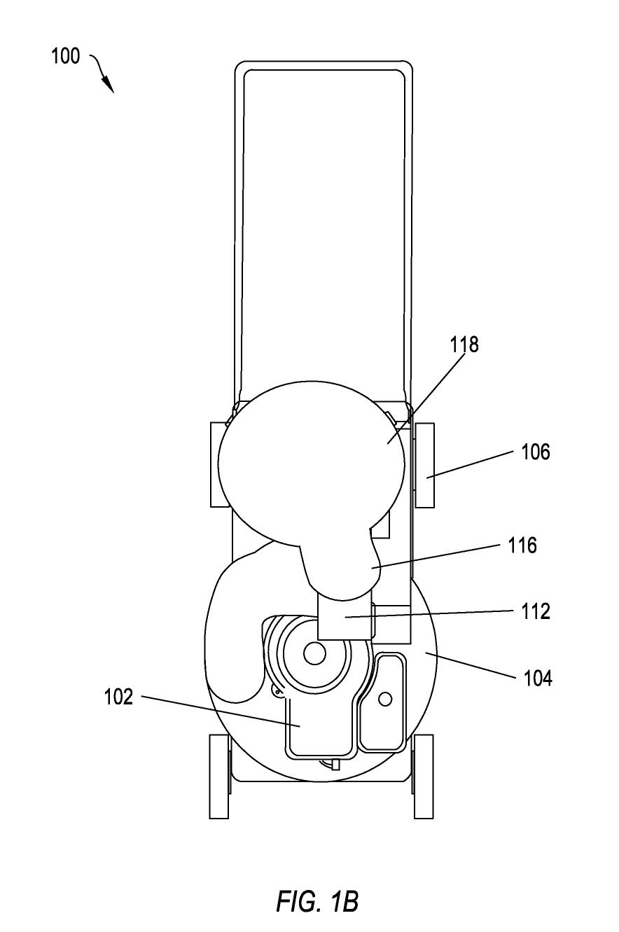

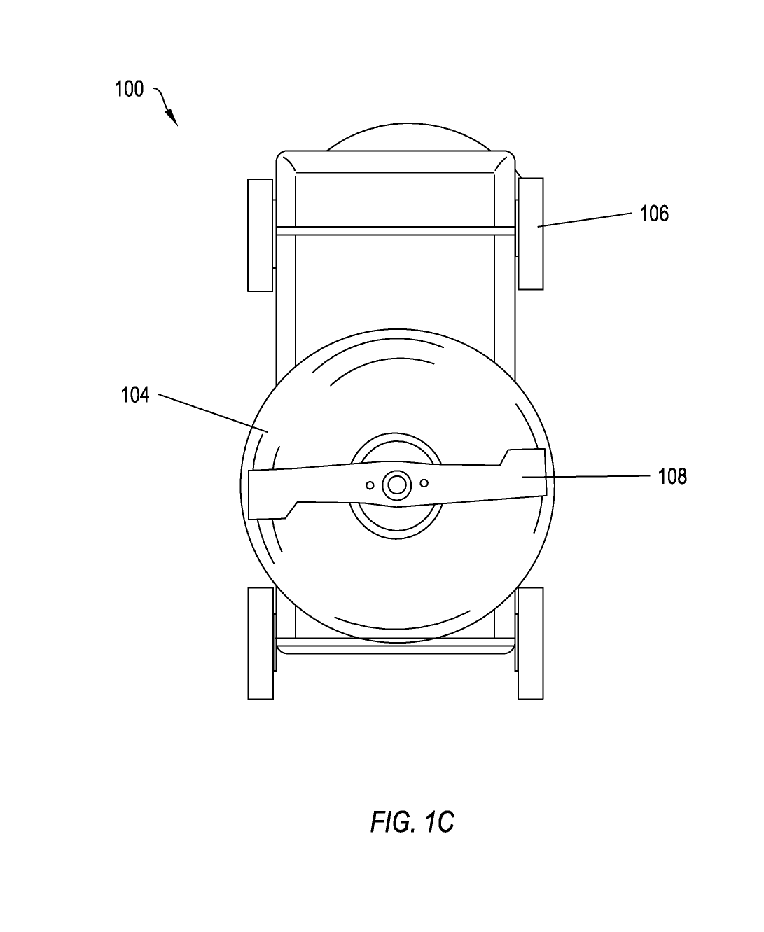

FIGS. 1A, 1B and 1C illustrate an example of a system 100 for collecting yard debris. FIG. 1A illustrates a side view of the system 100 for collecting yard debris; FIG. 1B illustrates a top view of the system 100 for collecting yard debris; and FIG. 1C illustrates a bottom view of the system 100 for collecting yard debris. In at least one implementation the system 100 can be used to mulch and collect yard debris. For example, the system 100 can be used to mow and mulch grass clippings or mulch and collect other yard debris, such as leaves.

FIGS. 1A, 1B and 1C show that the system 100 can include an engine 102. In at least one implementation, the engine 102 is configured to produce mechanical motion within the system 100. In particular, the engine 102 can provide the power which is used to operate the system 100. The engine 102 can produce the power by burning fuel, by using electrical energy or by any other desired means. The power produced by the engine 102 can be used to mulch yard debris, move the yard debris, move the system 100 or perform any other desired work.

FIGS. 1A, 1B and 1C also show that the system 100 can include a housing 104. In at least one implementation, the housing 104 is configured to contain other elements of the system 100. In particular, the housing 104 can keep the elements of the system 100 in their proper position, even when moving at high speeds. This can protect both the system 100 and the user in the case of a breakdown or other mechanical failure.

FIGS. 1A, 1B and 1C further show that the system 100 can include one or more wheels 106. In at least one implementation, the one or more wheels 106 can be used to support the system 100. In particular, the one or more wheels 106 can allow the user to move the system 100 over a desired surface. The one or more wheels can be adjusted to change the height of the system 100.

FIGS. 1A, 1B and 1C additionally show that the system 100 can include a cutting blade 108. In at least one implementation, the cutting blade 108 is configured to mulch any yard debris collected by the system 100. In particular, the cutting blade 108 can be rotated by the motor, either about a vertical axis or a horizontal axis, by the engine 102. The cutting blade 108 can be rotated at a high rate of speed. As the cutting blade 108 encounters an obstacle, such as yard debris or grass, the high rate of rotation can prevent the cutting blade 108 from being caught up, or cutting only partially though the obstacle or having its motion slowed by the obstacle. In addition, a high speed of rotation can prevent the cutting blade 108 from pushing the obstacle. I.e., even though the obstacle is free to move, the cutting blade 108 can pass through the obstacle because of the large difference in speed between the cutting blade 108 and the obstacle. Additionally or alternatively, the cutting blade 108 can create an upward motion of air within the housing 104. The air can lift yard debris into the path of the cutting blade 108, ensuring that the obstacles are thoroughly mulched.

FIGS. 1A, 1B and 1C also show that the system 100 can include a debris chute 110. In at least one implementation, the debris chute 110 can allow mulched debris to exit the housing 104. I.e., the yard debris can be mulched by the cutting blade 108 and then exit the housing 104 via debris chute 110. Directing the mulched debris through the debris chute 110 can allow the debris to be collected and disposed of, as described below.

FIGS. 1A, 1B and 1C further show that the system 100 can include a pump 112. In at least one implementation, the pump 112 can be configured to accelerate the mulched debris as it leaves the housing 104 via the debris chute 110. In particular, the pump 112 can increase the air velocity of the mulched debris in the debris chute 110. The air can then carry the mulched yard debris at the desired rate. Additionally or alternatively, the pump 112 can chop the mulched debris into finer particles. In particular, the pump 100 can include fan blades or other apparatus for moving the air which are capable of further mulching the yard debris.

FIGS. 1A, 1B and 1C additionally show that the pump 112 can be attached to the engine 102 by a belt 114. In at least one implementation, the belt 114 can transfer power produced by the engine 102 to the pump 112, operating the pump 112. In particular, the belt 114 is rotated by the engine 102. The belt 114 then turns an element of the pump 112. The rotational motion can be converted to electrical power or converted to mechanical motion which is used to move air through the pump 112.

FIGS. 1A, 1B and 1C also show that the system 100 can include an outtake chute 116. In at least one implementation, the outtake chute 116 can allow air and mulched debris to exit the pump 112. In particular, the outtake chute 116 can control the movement of the mulched yard debris as it leaves the pump 112 to ensure that the yard debris is moved to the appropriate location.

FIGS. 1A, 1B and 1C further show that the system 100 can include a filter element 118. In at least one implementation, the filter element 118 can prevent the escape of dust and other yard debris. In particular, the filter element 118 can allow the air pressure created by the upward air motion created by the cutting blade 108 and the pump 114 to be relieved. I.e., the filter element 118 can allow air to escape but contain the mulched yard debris. Additionally or alternatively, the filter element 118 can be the highest point in the system along which the mulched yard debris moves. With the air pressure substantially removed, the mulched yard debris can then move in the desired direction under the remaining air pressure and the force of gravity.

FIGS. 1A, 1B and 1C additionally show that the system 100 can include a bag 120. In at least one implementation, the bag 120 can be used to collect the mulched yard debris. For example, the bag 120 can include a compostable bag. In particular, a compostable bag is any bag that made of organic matter that has can decompose and be recycled as a fertilizer and soil amendment. I.e., the bag 120 can be used, along with the mulched yard debris, as compost material.

FIGS. 1A, 1B and 1C also show that the system 100 can include an adjustable hoop 122. In at least one implementation, the adjustable hoop 122 can be used to attach the bag 120 to the filter element 118. In particular, the adjustable hoop 122 can allow the operator to remove the bag 120 and replace the bag 120 as needed, as described below. The adjustable hoop 122 can be located partially within a hem of the filter element 118. Locating the adjustable hoop 122 within a hem of the filter element 118 can allow the bag to be more easily inserted, as described below.

FIGS. 1A, 1B and 1C further show that the adjustable hoop 122 can attach the bag 120 in a vertical orientation. I.e., the bag 120 can have an opening which is oriented at the top of the bag 120 when attached to the filter element 118 by the adjustable hoop 122. In at least one implementation, a vertical alignment of the bag 120 can allow the mulched yard debris to be packed more tightly into the bag 120. I.e., the mulched yard debris falls, under the force of gravity and the air movement created by the pump 112, into the bag 120. The weight of mulched yard debris compacts all lower mulched yard debris, allowing more mulched yard debris to be packed into the bag 120 and for the mulched yard debris to be packed more tightly.

FIGS. 1A, 1B and 1C additionally show that the system 100 can include a platform 124. In at least one implementation, the platform 124 can be used to support the bag 120. In particular, the bottom of the bag 120 can rest on the platform 124, supporting the weight of the bag 120 and any mulched yard debris within the bag 120.

FIGS. 1A, 1B and 1C also show that the system 100 can include a support frame 126. In at least one implementation, the support frame 126 can allow the bag 120 to remain in a vertical orientation. Additionally or alternatively, the support frame 126 can support portions of the filter element 118 and the adjustable hoop 122 during operation of the system 100 and during installation and removal of the bag 120.

One of skill in the art will appreciate that the system 100 can include any means for mowing or mulching yard debris. For example, the system 100 can include a riding mower or lawn vacuum. Additionally or alternatively, the system 100 can include additional elements if desired. For example, the system 100 can include a propulsion mechanism capable of moving the system 100. I.e., any system that is capable of collecting and/or mulching yard debris is contemplated herein and may be used without restriction unless otherwise stated in the claims.

One of skill in the art will also appreciate that the system 100 can include other elements for supporting the functions of the disclosed elements. Additionally or alternatively, the system 100 can include safety elements, such as covers, frames or safety shutoffs, which are designed to protect the user.

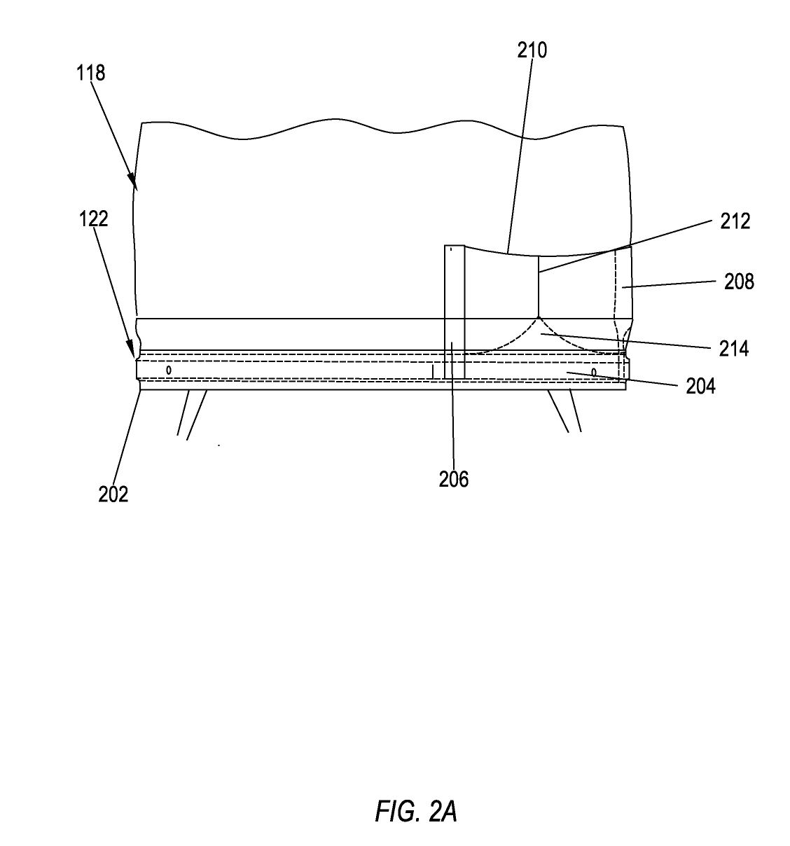

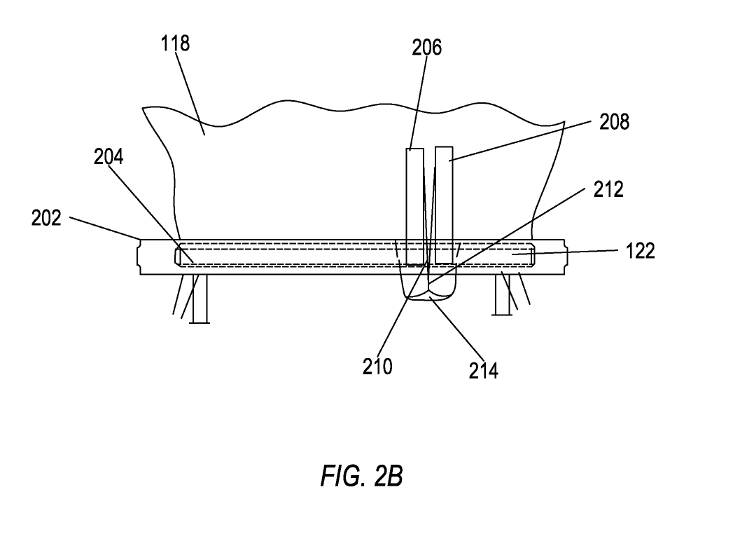

FIGS. 2A and 2B illustrate an example of an adjustable hoop 122 attached to a filter element 118. FIG. 2A illustrates an example of the adjustable hoop 122 in an expanded position attached to a filter element 118; and FIG. 2B illustrates an example of the adjustable hoop 122 in a contracted position attached to a filter element 118. In at least one implementation, a portion of the adjustable hoop 122 can be located within a hem of a filter element 118. In particular, locating a portion of the adjustable hoop within a hem of a filter element 118 can ensure that the adjustable hoop 122 is properly placed during operation, as described below.

FIGS. 2A and 2B show that the adjustable hoop 122 can include an outer hoop 202. In at least one implementation, the outer hoop 202 can be secured to a frame 126. In particular, the outer hoop 202 can be attached such that it remains stationary or substantially stationary even while a bag is being changed.

FIGS. 2A and 2B also show that the adjustable hoop 122 can include an inner hoop 204. In at least one implementation, the inner hoop 204 can mate with the outer hoop 202. In particular, the diameter of the inner hoop 204 can be adjusted. I.e., the diameter can be reduced, in order to separate the inner hoop 204 from the outer hoop 202; alternatively, the diameter of the inner hoop 204 can be increased in order to allow the inner hoop 204 to mate with the outer hoop 202, as described below.

In at least one implementation, the inner hoop 204 can be biased to an expanded position. I.e., the inner hoop 204, free of any external force, can naturally assume an expanded position. Such biasing can allow the inner hoop 204 to remain in position during operation. In particular, the inner hoop 204 will expand to meet the outer hoop 202 unless an external force is applied to the inner hoop 204 which removes the inner hoop from the outer hoop.

FIGS. 2A and 2B further show that the inner hoop 204 can be located, at least partially, within a hem of the filter element 118. In particular, contracting the inner hoop 204 can contract at least a portion of the hem of the filter element 118. In contrast, as the inner hoop 204 expands to mate with the outer hoop 202 the filter element 118 will be placed to create a seal which prevents debris from escaping during operation.

FIGS. 2A and 2B additionally show that the adjustable hoop 122 can include a first handle 206. In at least one implementation, the first handle 206 can be stationary relative to the filter element 118. Additionally or alternatively, the first handle 206 can include a spring-loaded clamp. The spring-loaded clamp can constrain the inner hoop 204 in the desired state of contraction for movement of the bag by the user.

FIGS. 2A and 2B also show that the adjustable hoop 122 can include a second handle 208. In at least one implementation, the second handle 208 is not stationary relative to the filter element 118. This can allow the second handle 208 to move relative to the first handle 206. Moving the second handle 208 relative to the first handle 206 can allow the diameter of the inner hoop 204 to be increased or decreased as desired by the user. In particular, as the distance between the first handle 206 and the second handle 208 is reduced, the diameter of the inner hoop 204 is reduced; alternatively, as the distance between the first handle 206 and the second handle 208 is increased, the diameter of the inner hoop is increased, as described below.

FIGS. 2A and 2B further show that the adjustable hoop can include a tension line 210. In at least one implementation, the tension line 210 can be used to ensure a seal between the filter element 118 and an installed bag. I.e., the tension line 210 can be used to ensure that as the inner hoop 204 expands and mates with the outer hoop 202, then filter element 118 provides an adequate seal. Additionally or alternatively, the tension line 210 can ensure that as the inner hoop 204 is contracted, the filter element, or a portion thereof, is moved out of the way, allowing access to the opening between the outer hoop 202 and the inner hop 204, allowing a bag to be removed or installed, as described below.

FIGS. 2A and 2B additionally show that the adjustable hoop 122 can include a line connector 212. In at least one implementation, the line connector 212 can be used to move a portion of the filter element 118 into a proper position to seal when the inner hoop is in its expanded state. One of skill in the art will appreciate that as the first handle 206 and the second handle 208 are moved toward one another, the tension line 210 will have slack introduced; this, in turn, allows the line connector 212 to be lowered, under the force of gravity. In contrast, as the first handle 206 and the second handle 208 are moved apart from one another, the tension line 210 will have slack removed; this, in turn, raises the line connector 212.

FIGS. 2A and 2B also show that the filter element 118 can include a segment 214 connected to the line connector 212. In at least one implementation, the segment 214 can wrap around the inner hoop 204; however, the segment 214 can lack any direct connection to the inner hoop 204. The lack of a direct connection can allow the segment 214 to move relative to the inner hoop 204. In particular, as the line connector 212 pulls up on the segment 214, the segment 214 can be pulled taut relative to the inner hoop 204. This can ensure that the filter element 118 can be pulled against the inner hoop 204, creating a seal.

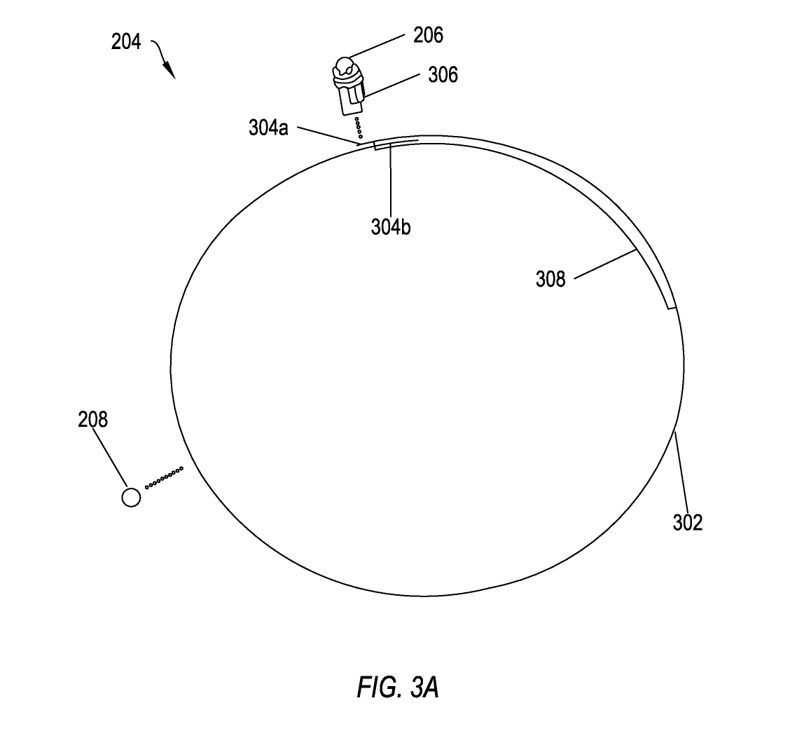

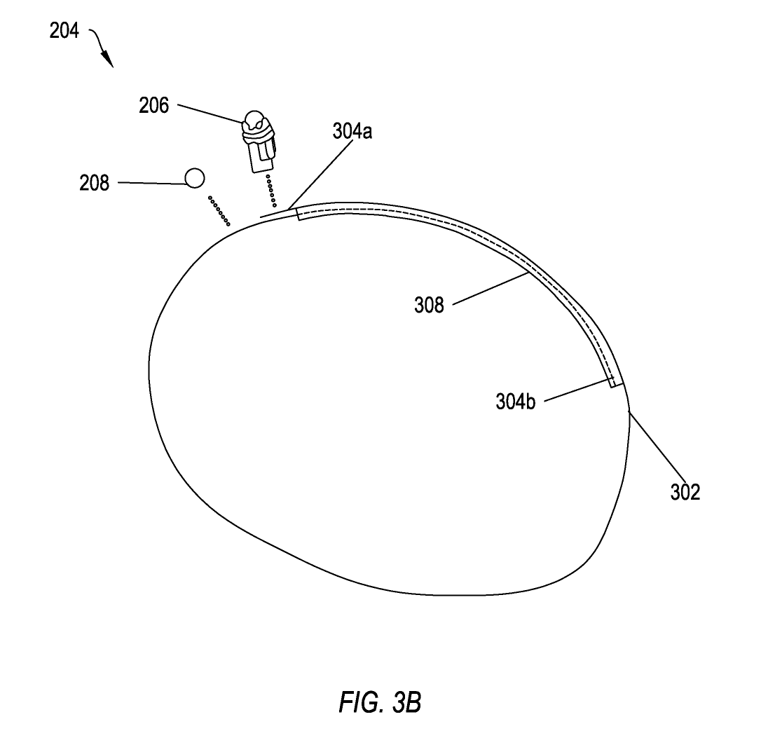

FIGS. 3A and 3B illustrate an exploded view of an example of an inner hoop 204. FIG. 3A illustrates an exploded view of the inner hoop 204 in an expanded position; and FIG. 3B illustrates an exploded view of the inner hoop 204 in a contracted position. In at least one implementation, the inner hoop 204 can secure a bag in a desired position. In particular, the inner hoop 204 can ensure a seal between a filter element and a bag.

FIGS. 3A and 3B show that the inner hoop 204 can include a band 302. In at least one implementation the band 302 can be curved to form an approximately round shape. For example, the band 302 can be curved to form an approximately circular shape or an approximately elliptical shape. The band 302 can be made of any suitable material. For example, the band 302 can be made of metal or other material that is of sufficient strength to support a full bag while in use, as described below. As used in the specification and the claims, the term approximately shall mean that the value is within 10% of the stated value, unless otherwise specified.

FIGS. 3A and 3B also show that the band 302 can include a first end 304a and a second end 304b (collectively “ends 304”). In at least one implementation, the first end 304a and the second end 304b are configured to move relative to one another. In particular, when the inner hoop 204 is contracted, the first end 304a is moved further from the second end 304b; and when the inner hoop 204 is expanded, the first end 304a is moved closer to the second end 304b.

FIGS. 3A and 3B show that the first handle 206 is attached near the first end 304a. In at least one implementation, the first handle 206 is fixed in position relative to the attached filter element. In particular, the first handle 206 can be used for leverage to contract the inner hoop 204, as described below. Additionally or alternatively, the first handle 206 can include a spring-loaded clip 306. In at least one implementation, the spring-loaded clip 306 can be used to hold the position of the band 302 near the second end 304b relative to the first end 304a. I.e., when the user has either contracted or expanded the inner hoop 204 to the desired size, the spring-loaded clip 306 can retain the inner hoop 204 at the desired size.

FIGS. 3A and 3B further show that the inner hoop 204 can include a channel 308. In at least one implementation, the channel 308 can ensure that overlapping sections of the band 302 remain near one another. I.e., the channel 308 can ensure that during contraction the band 302 retains an approximately round shape. In particular, keeping the overlapping sections of the band 302 can prevent either end of the band 302 from protruding and causing injury to the user or damaging the filter element or bag.

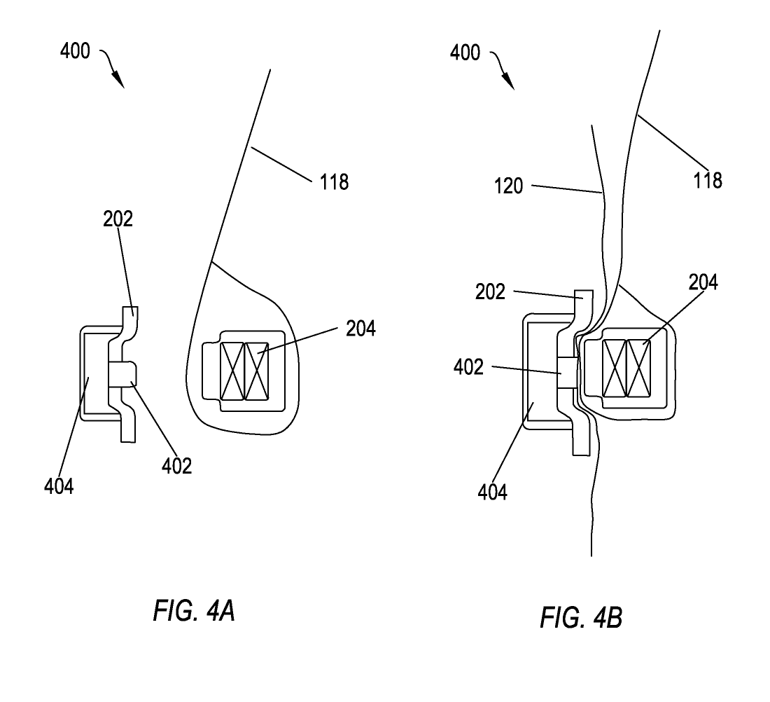

FIGS. 4A and 4B illustrate an example of an interlock switch 400. FIG. 4A illustrates an example of an interlock switch 400 in a disabled position; and FIG. 4B illustrates an example of an interlock switch 400 in an enabled position. In at least one implementation, the interlock switch 400 can be used to enable or disable operation of a system for collecting yard debris. In particular, the interlock switch 400 can disable operation of the system if the inner hoop 204 is not properly mated with the outer hoop 202 and enable operation of the system if the inner hoop 204 is not properly mated with the outer hoop 202, whether or not a bag 120 is present between the inner hoop 204 and the outer hoop 202.

FIGS. 4A and 4B show that the interlock switch 400 can include a plunger 402. In at least one implementation, the plunger 402 can indicate whether the inner hoop 204 is in contact with the outer hoop 202. In particular, if the inner hoop 204 is in contact with the outer hoop 202, the plunger 402 will be pushed by the inner hoop 204. I.e., the plunger 402 will be in an extended position when the inner hoop 204 has been separated from the outer hoop 202. In contrast, the plunger 402 will be in a pushed-in position when the inner hoop 204 is in contact with the outer hoop 202. The plunger 402 can be pushed in, whether or not a bag 120 is placed between the inner hoop 204 and the outer hoop 202.

FIGS. 4A and 4B also shows that the interlock switch 400 can include a housing 404. In at least one implementation, the housing 404 can receive the plunger 402. In particular, the housing 404 can include mechanical or electronic means for detecting when the plunger 402 is depressed and/or providing a disable or enable signal, as desired. For example, the housing can include a switch which grounds the ignition mechanism so that unless the plunger 402 is depressed, ignition is prevented.

In at least one implementation, a system for collecting yard debris can include multiple interlock switches 400. For example, the outer hoop 202 can include two or more interlock switches 400, each of which must be enabled before the system can be operated. Additionally or alternatively, the outer hoop 202 can include a single interlock switch 400 which must be enabled before the system can operate.

### Operation

The following is provided as an example of operation and is not intended to be limiting. In particular, the following discussion assumes the presence of elements which may or not be present, depending on the preferences of the user.

To remove the full bag 120 the operator turns off the system 100. The operator squeezes the first handle 206 with his left hand, releasing the second handle 208 and the second band 302. The operator pushes the second handle 208 with his right hand toward the first handle 206 which he is holding in his left hand. When the first handle 206 and the second handle 208 are adjacent he releases the first handle 206 locking the adjustable hoop 122 in the contracted position. Now there is ample clearance between the filter element 118 and the bag holder frame outer hoop 202 for bag 120 removal and replacement. The operator removes the full bag 120 from the machine.

The operator opens up the new bag 120 before installing it on the machine. The rectangular mouth of the bag 120 is placed over the contracted filter element 118 and the adjustable hoop 122. The bottom of the bag 120 is placed on the platform 124. The operator once again gasps the first handle 206 and squeezes with his left hand, releasing the second handle 208 and the second end 304b. The operator grasps the second handle 208 with his right hand and pulls it away from the first handle 206 until the tension line 210 is tight. By moving the first handle 206 and the second handle 208 apart the operator forces the normally rectangular mouth of the bag 120 into an oval shape by forming it between the bag holder frame outer hoop 202, and the adjustable hoop 122. The oval shape maximizes the cross-sectional opening of the bag. Before releasing the clamp the operator guides the adjustable hoop 122, the filter element 118 and bag 120 into the bag holder frame outer hoop track groove 204. The bag 120 is now sealed in place and all the hoop set interlock switch plungers 402 are depressed. The machine is enabled.

The operator starts the machine and guides or pushes the system 100 over grass and or leaves. The cutting blade 108 cuts the grass, mulches the grass or leaves and throws the mulch into the pump intake chute 110. The pump intake chute 110 conducts the mulch into the pump 112, where it is mulched further. The pump 112 impels the mulch through the pump output chute 116 and into the filter element 118. The filter element 118 allows pump derivative air to pass through and escape but the mulch is trapped inside. The large empty area at the bottom of the filter element 118, facilitated by the adjustable hoop 122, allows the heavier than air mulch to fall by gravity to the bottom of the open bag 120.

The operator monitors the level of the mulch in the bag 120. He does this by pressing his hand into the side of the bag 120 or using any other desired method. The side of the bag 120 packed solid with mulch will feel firm to the touch. The side of the bag 120 unpacked will yield to his touch. The operator continues to mow until the level of the mulch reaches the desired height, usually a few inches below the bag holder frame outer hoop 202. If the mulch is heavy the desired level may be lower in order to control the weight of the full bag 120.

When the bag 120 is filled to the desired level the operator would stop the machine and repeat the sequence of bag 120, removal and replacement.

If the operator fails to make a proper seal between the filter element 118, the bag 120, the outer hoop 202 and the inner hoop 204, then the plungers 402 would not depress completely. This would leave at least one hoop set interlock switch 400 closed and the machine disabled in order to protect the operator from flying mulch.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An expandable hoop for securing a bag to a system for cleaning up yard debris, the expandable hoop comprising:
an outer hoop; and
an inner hoop, wherein the inner hoop:
is configured to mate with the outer hoop; and
includes:
a band, wherein the band is curved to form a round shape; and
an overlapping section of the band, wherein the overlapping section can allow:
an expanded configuration, wherein the expanded configuration occurs if the inner hoop overlap is small; and
a contracted configuration, wherein the contracted configuration occurs if the inner hoop overlap is large.

2. The expandable hoop of claim 1 further comprising:
a first handle, wherein the first handle is configured to secure the overlapping section.

3. The expandable hoop of claim 2, wherein the first handle includes a spring loaded clip.

4. The expandable hoop of claim 2 further comprising:
a second handle, wherein the second handle is configured to increase or decrease the amount of inner hoop overlap.

5. The expandable hoop of claim 1 further comprising:
an interlock switch, wherein the interlock switch is configured to disable the system when the outer hoop is not mated to the inner hoop.

6. The expandable hoop of claim 5, wherein the interlock switch includes a plunger.

7. The expandable hoop of claim 6, wherein the interlock switch includes a housing, wherein the housing is configured to receive the plunger.

8. The expandable hoop of claim 7, wherein the housing is configured to produce an electrical signal which indicates one of:
the plunger is depressed; or
the plunger is not depressed.

9. The expandable hoop of claim 6, wherein the plunger is depressed by the mating of the inner hoop with the outer hoop.

10. The expandable hoop of claim 6, wherein the interlock switch grounds the ignition system when the plunger is not depressed.

11. The expandable hoop of claim 1 wherein the round shape is one of:
circular; or
elliptical.

12. A system for cleaning up yard debris, the system comprising:
a lawn mower, wherein the lawn mower:
is configured to mulch the yard debris; and
includes a blade, wherein the blade is configured to spin approximately parallel to the ground;
a pump, wherein the pump is configured to:
lift the mulch created by the mower;
a bag, wherein the bag is configured to receive the mulch lifted by the pump; and
a filter, wherein the filter is located at the attachment of the pump and the bag;
an expandable hoop, wherein the expandable hoop is configured to attach the bag to the filter.

13. The system of claim 12 further comprising a belt, wherein the belt is configured to transfer power from the engine to the pump.

14. The system of claim 13 further comprising a second belt, wherein the second belt is configured to transfer power from the engine to one or more wheels.

15. The system of claim 12 wherein at least a portion of the expandable hoop is located within a hem of the filter.

16. A system for cleaning up yard debris, the system comprising:
a lawn mower, wherein the lawn mower:
includes a blade, wherein the blade is configured to spin approximately parallel to the ground; and
is configured to mulch the yard debris;
a pump, wherein the pump is configured to:
lift the mulch created by the mower;
a compostable bag, wherein the compostable bag:
is configured to receive the mulch lifted by the pump; and
is attached vertically to the mower, wherein vertical attachment of the compostable bag:
allows more mulched yard debris to be packed in the compostable bag; and
prevents the mulched yard debris from moving toward the operator;
a filter, wherein the filter is located at the attachment of the pump and the compostable bag;
an expandable hoop, wherein the expandable hoop:
attaches the compostable bag to the filter; and
includes:
an outer hoop; and
an inner hoop, wherein the inner hoop:
is configured to mate with the outer hoop; and
includes:
an overlapping section, wherein the overlapping section is configured to allow:
an expanded configuration, wherein the expanded configuration occurs if the inner hoop overlap is small; and
a contracted configuration, wherein the contracted configuration occurs if the inner hoop overlap is large; and
a first handle, wherein the first handle is configured to secure the overlapping section; and
a second handle, wherein the second handle is configured to increase or decrease the amount of inner hoop overlap; and
an interlock switch, wherein the interlock switch is configured to disable the system when the outer hoop is not attached to the inner hoop.

17. The system of claim 16, wherein the first handle includes a spring loaded clip.

18. The system of claim 16 further comprising a channel, wherein the channel is configured to ensure that the overlapping section of the band remains in proximity.

19. The system of claim 16 further comprising a tension line attached to the first handle and the second handle.

20. The system of claim 19 further comprising a line connector, wherein the line connector is configured to connect the tension line to a portion of the filter element.
